(19) United States
(12) Patent Application Publication
(10) Pub. No.: US 2011/0196551 A1
(43) Pub. Date: Aug. 11, 2011

(54) SYSTEM AND METHOD FOR SITUATION SPECIFIC GENERATION AND ASSESSMENT OF RISK PROFILES AND START OF SUITABLE ACTION FOR PROTECTION OF VEHICLES

(75) Inventors: Thilo Lees, Tapfheim (DE); Florian Regenfelder, Munchen (DE); Dominik Vogel, Rain Am Lech (DE)

(73) Assignee: EUROCOPTER DEUTSCHLAND GMBH, Donauworth (DE)

(21) Appl. No.: 13/007,728

(22) Filed: Jan. 17, 2011

(30) Foreign Application Priority Data
Jan. 20, 2010 (EP) 10 400001.3

(51) Int. Cl. G05D 1/00

(52) U.S. Cl. 701/14; 701/3

(57) ABSTRACT

The present invention relates to a vehicle system (1) and a method for a situation specific evaluation of risks in a surrounding of said vehicle (1), comprising a detection unit (2) for detecting and providing of situation specific data; a data transmitting unit and a data receiving unit (3), processing data from sources of data and communicating necessary data for such processing; and a processing unit (4), generating application data (14) based on received data The application data (14) is based on supplemental data stored in the processing unit (4) for a situation specific profile of hazards/risks. Suitable measures for maneuver control of the vehicle depending from such application data (14) is started.

### CROSS REFERENCE TO RELATED APPLICATIONS

This application claims the benefit of EP 10 400 001.3 filed on Jan. 20, 2010, the disclosure of which is incorporated in its entirety by reference herein.

### FIELD OF THE INVENTION

The present invention relates to a system for situation specific generation and assessment of risk profiles according to the features of the preamble of claim 1 and to a method for operating such a system to start suitable action for the protection of vehicles according to the features of the preamble of claim 8.

Military vehicles within the most general meaning, such as vehicles of terrestric-, nautical- or air units, have technical systems depending from area of mission and state of equipment detecting and signalling fire (guns, torpedo, RPG, missiles) or a future scenario of fire to a crew on board. This information enables the crew to introduce suitable measures, e.g. avoidance maneuvers, use of misleading objects, etc. to avoid harm of the crew and the vehicle or to minimize at least such harm if avoidance is not possible any more.

### BACKGROUND OF THE INVENTION

It is known in the state of the art to provide acoustical or optical signals indicating such information relating to immediately imminent danger situations. Technical systems inline with the sensors may consequently propose or introduce suitable countermeasures.

Aircrafts being operated in danger zones are exposed to risks of attack by fire particularly during low-level flight or at take-off or landing.

Such technical systems for detecting the approximate direction of the position of a gunner are sufficiently known in the state of the art. Examples for this state of the art are PILARw, FERRET or BOOMERANG, recording acoustical or pressure waves from an incoming object by means of microphones and/or pressure sensors and thus are determining the distance of a vehicle relative to the origin of the fired object. As incoming object, particularly a missile, any object might be considered, whose features, such as size and/or speed might be registered by a sensor and was classified as a threat. Examples might be—without limitation—a (gun-) projectile or a missile head (guided/unguided).

Any success of a countermeasure relative to a scenario of fire is essentially dependent on the quality of the available information allowing a most realistic evaluation of the danger situation in the shortest time possible. Up to now known systems are restrained to detect for example in a situation under fire the approximate direction of the place of origin of an oncoming object, i.e. the location of a gunner.

DE 10 20080020 959 discloses a method and a device for the detection of objects being under fire, particularly of vehicles, e.g. aircrafts, for tracing back the origin of an incoming object, particularly a projectile in order to move the vehicle under fire out of the danger zone. For this purpose an oncoming object in the surrounding of the vehicle is detected by means of a pulsed laser (situation under fire) allowing by means of the detected data generation of an avoidance maneuver out of the danger zone for the vehicle under fire initiated either automatically, by the pilot or a staff at a ground control. DE 10 20080020 959 discloses optical detection means such as cameras, CCD-cameras, CMOS, APD arrays and stereoscopic procedures providing data to a computer supported processor. This data may be prepared to give information regarding the trajectory of a bullet or missile or the place of origin of gunfire. The information from the processor of this known device may be used to directly and automatically take over the control of the aircraft. The information from the processor may as well be passed on to the crew on board if the vehicle is equipped with a cockpit display or a helmet mounted display. Via a data interface and radio or satellite communication the detected data regarding the projectile may as well be transmitted to a staff at ground control. More complex information can not be proceeded by this known method and device according to DE 10 20080020 959.

### SUMMARY OF THE INVENTION

The objective of the present invention is to provide for a system and a method allowing decisions sensitive relative to the security in a situation under fire to start countermeasures more quickly and more precisely. A further objective of the present invention is to provide for a system and a method providing countermeasures depending from a situation with a maximum of efficiency in order to avoid hits or to at least minimize them. It is a further objective of the present invention to provide for a system and a method allowing generation of a most realistic and precise representation of the risk and surrounding situation and the introduction of situation specific countermeasures on this basis and it is a further objective of the present invention to provide on time in advance for the detection of the trajectory and a possible point of hit of the oncoming object.

These objectives are solved with a system with the features of claim 1 and a method according to claim 8.

According to the invention a system and a method are provided allowing the combination of different sources of data including supplemental data regarding condition of the vehicle, information relative to the surrounding, etc. to provide for a most realistic and precise representation of the risk and surrounding situation and providing the option of introducing situation specific countermeasures on this basis. These countermeasures have as an object to avoid—if possible—directly the oncoming object in order to avoid a hit or at least in order to minimize any damage that can't be avoided anymore. Consideration of supplemental data or parameters for the conception of suitable countermeasures, e.g. avoidance maneuvers, is not disclosed in DE 10 20080020 959.

With the detection of a plurality of important input factors and parameters by sensors for the generation of data sensitive to the security of the vehicle, combination of this data with supplemental data provided relative to vehicle condition, information regarding the surrounding, etc. and the consequent evaluation of a risk situation for vehicles in mission areas according to the invention a detailed risk/hazard profile specific for the situation of the vehicle and its crew can be provided representing a precise copy of the respective risk situation. A further essential feature of the inventive system and method is that the trajectory and the supposed hit area of an oncoming object to the vehicle can be predicted. Thus suitable countermeasures, i.e. countermeasures specific to the situation, can be initiated in order to avoid or at least minimize damages to the vehicle, particularly at vehicle parts sensitive for the security and for the crew.

According to a first embodiment of the invention the detection unit is conceived in such a way that characteristic data information regarding the surrounding of the vehicle is provided in order to generate a realistic profile of the surrounding. This profile of the surrounding is taken into consideration for the calculation of a risk/hazard profile. Parameters for the profile of the surrounding can be current information regarding climatic conditions by way of weather data, GPS-navigation data, building information and map information and other surrounding specific specialities in the respective area of mission. Map-information may be stored in the system of the vehicle and may be updated if needed on request or from an external station.

According to a second embodiment of the system an interface for data communication is provided allowing the vehicle to send data to other vehicles, air based communication facilities, sites on the ground or on/in the water or allowing the vehicle to receive such data. This is particularly important in quickly changing situations in order to update the systems on board with current data of the respective area of mission the current data being inquired by the crew or the system itself. A further option is to automatically compare the data for safety sensitive components of the vehicle operated from external control sites to adapt the vehicle to the respective situations and areas of mission.

Preferably data is communicated via an encrypted interface. Thus it is guaranteed that safety sensitive information e.g. vehicle data or targets of mission are transmitted exclusively to the designated receiver. A further option is data exchange with vehicles nearby to coordinate the computed countermeasures in a situation under fire with vehicles within the radius of action in order to avoid collisions with vehicles nearby during avoidance maneuvers.

A further preferred embodiment of the present system is its ability to inquire the current operation and configuration status of the components of the vehicle, particularly for the safety sensitive components of the vehicle. On the basis of this information computed countermeasures such as avoidance maneuvers and/or shedding of objects/ballast may be adapted to the respective state of the vehicle and to the type of the vehicle. The same way this information regarding status may be used to determine any damage in order to give a detailed status of the remaining operability of the vehicle. This information may be communicated already during the mission to respective communication sites thus allowing for preparation of damage analysis and repair even before the aircraft has returned to its base. A further option is to combine this data with the situation and surrounding data to a risk profile dependent of the situation.

### BRIEF DESCRIPTION OF THE DRAWINGS

A preferred example of the invention is given by way of a non-limiting embodiment as presented in the attached drawings. It is shown in

FIG. 1 an embodiment of the system according to the invention,

FIG. 2 a flow chart of the system according to the invention, and

FIG. 3 a flow chart regarding input and output of a system according to the invention.

### DETAILED DESCRIPTION OF THE PREFERRED EMBODIMENTS

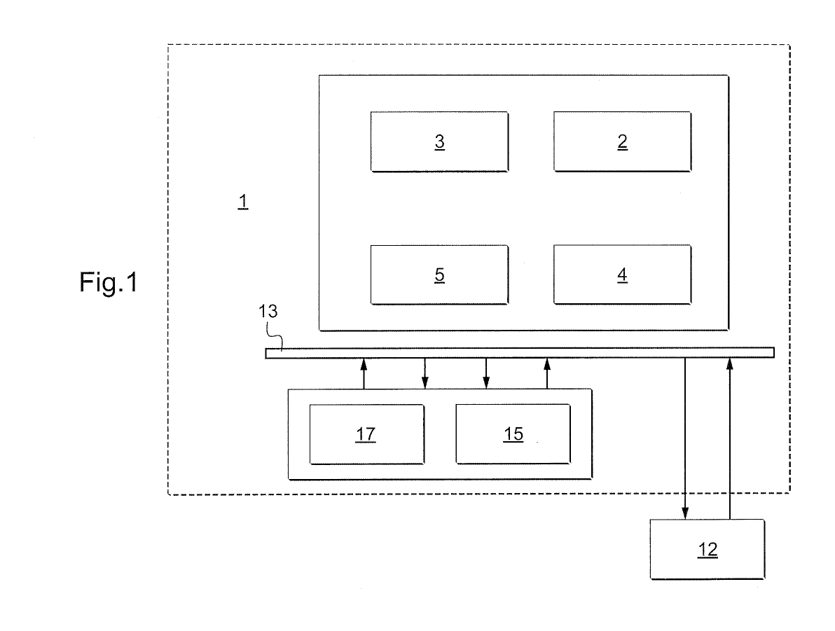

FIG. 1: A system 1 comprises a detection unit 2, a data receiving—and—transmitting unit 3, a processing unit 4 and optional storage elements 5.

The detection unit 2 of system 1 is equipped with different types of sensors 6, 7, 8, to provide multiple information regarding possible danger situation. The plurality of sensors 6, 7, 8 are mounted to the vehicle. There are basically two different types of sensors 6, 7, 8:

A first type sensor 6 for detection of so-called situation data 9 scanning the surrounding of the vehicle in regular intervals and providing information whether oncoming objects like gunfire have to be expected in a defined surrounding radius of the vehicle. Such oncoming objects can be classified in order to assess their potential danger for the vehicle. Examples of application for such sensors and systems for detection of oncoming objects in a situation under fire may be: Laser- or Radar alert system, MILOWS (Military variant/Military Obstacle Warning System), MILDS (Missile Launch Detection System), BRDS (Bullet Rocket Detection System), DIRCM (Directed Infrared Counter Measures), 1d/2d radar (d=dimensional) etc. Some of these first type sensors are able to detect information such as the type of fire, localisation of the place of origin but particularly the supposed trajectory and the place and time of hit of the oncoming object at the vehicle.

A second type of sensors 7 surveys the condition of the vehicle and the operability of the components sensitive for the safety and creates so called vehicle condition data 10. This information helps to decide, which countermeasure can be started in a danger situation for the respective vehicle and the vehicle is still able to perform in its current (equipment-) condition and current characteristics of mobility, in order to keep the damage as low as possible. Examples for such characteristics are: GPS, IMU, Altitude, TOW, Fuel-level, IAS (indicated air speed), Heading, TQ MGB/condition of the engine, information regarding weight and load of the vehicle, datalink, etc. Further parameters of the vehicle such as the size and areas of the vehicle sensitive for safety may be inquired from respective data registrations in data bases.

A third type of sensor 8 possibly mounted on the vehicle provides for so-called surrounding data 11 to the processing system. These enter as well into the calculation of the risk/hazard profile. Surrounding data 11 may be: weather information, building information or more important map-data regarding the respective area of mission. Current parameters of surrounding data 11 but as well information regarding situation or vehicle data may be stored in data memories integral to the vehicle or may be transferred to the system 1 via a data communication interface during a mission.

The data receiving—and—transmitting unit 3 receives data from different data sources and passes them on towards components of the vehicles system 1 and/or external technical systems 12. These data might be sent from other vehicles, ground controls and from the sensors 6, 7, 8 of the detection-unit 2 being part of the vehicle. The data may be transferred after suitable processing via a data communication interface 13 to the external sources 12 such as ground controls or vehicles.

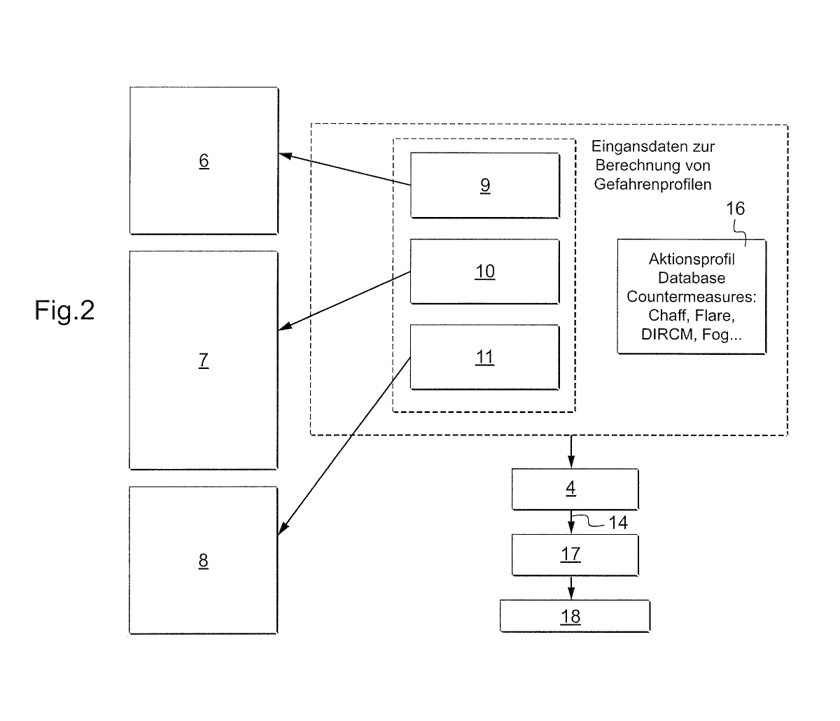

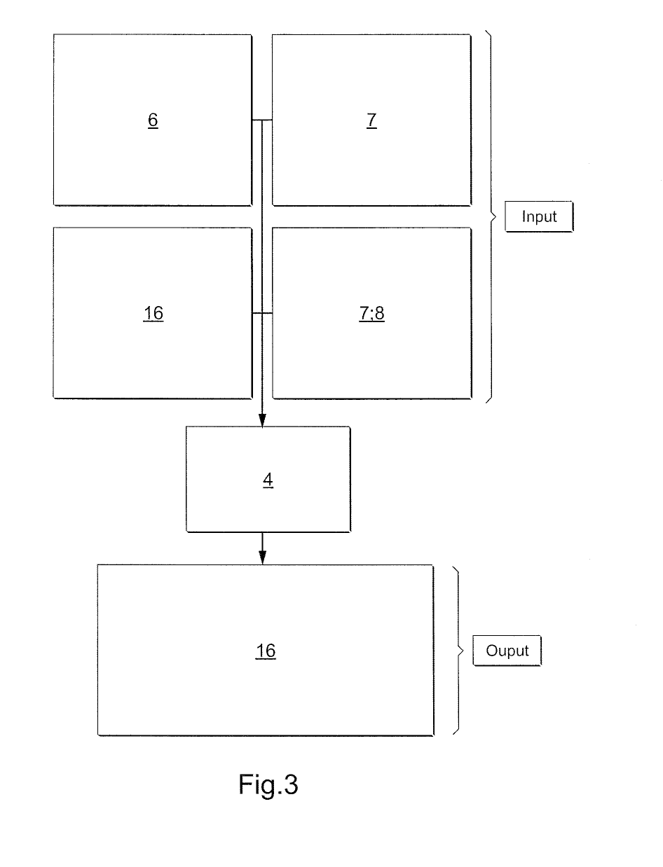

The processing unit 4 of the system 1 processes the incoming information/parameters of the situation data 9, vehicle condition data 10 and surrounding data 11, as detailed in FIG. 2, and generates a situation specific risk/hazard profile allowing consideration of further information parameters from linked data bases. This risk/hazard profile consists of application data 14. The application data is used to provide proposals for countermeasures presented as profiles of solution such as avoidance maneuvers, FIG. 3. These may be transferred to the pilot by optical means, e.g. on a display-unit 15 and/or by acoustic means via signals. A further option is the transfer of the respective control commands directly to the vehicle control in order to start automatically countermeasures 18 for course corrections of the vehicle, if a risk/hazard profile stored in the data base fulfils the important criteria. Predefined control actions might be assigned for respective different risk/hazard profiles to be executed automatically by the system 1 in a defined risk situation or might be proposed to the pilot. This way a reaction time to any risky action ahead can be minimized in order to take the vehicle and/or safety sensitive components of such vehicle out of the danger zone or to avoid or minimize hits by oncoming objects. Such risk/hazard profiles may be stored in a database as so called action profiles 16 as presented in the embodiment of FIG. 2.

Countermeasures may be the following actions: automatical maneuvers via AFCS, use of fake bodies for missiles (Chaff/Flare), DIRCM, fog production to prevent sight against optically controlled missiles, dumping of external loads, optical and/or acoustic warnings or presentation of recommended maneuvers on a display. Particularly while preparing an avoidance maneuver there may be an option not to take the entire vehicle out of the danger zone if there is not sufficient time for such actions. Depending from the particular circumstances of the situation the system is therefore able to define avoidance maneuvers taking safety first of all sensitive components of the vehicle such as control elements or drive shafts in such a way into a new starting position that they are out of the calculated trajectory of the oncoming object. Thus it can be made sure that no or minimal damage is caused to essential and safety sensitive system components of the vehicle in case of an inevitable impact of the object into the vehicle. The system is able to add priorities as to which technical components of the system should tolerate the most minimal damage in case of an inevitable hit by an object, for example allowing the vehicle to land safely, to reach a nearby base or—if possible —to take contact by way of radio—or data communication with a base or an accompanying vehicle. Priorities means in this application case, to gradually classify which of the cited actions in the current impact scenario can still be or should be executed. The classification may be dependent of evaluation criteria for the situation, being dictated by the system 1 on the basis of the detected data for the situation, the vehicle, the surrounding or the user.

The processing unit 4 may if needed inquire the current status of the components on board in order to generate a new risk/hazard profile depending of the application and mission situation. The level of knowledge of the operability of single components of the system, —particularly after a damage has occurred by contact with an object such as gunfire—is important in order to evaluate the remaining possibilities, resources for countermeasures and their prospects of success in further situations under fire. In case of several sources of danger/threats a classification would be possible and the risk/hazard profile could be adapted according to the facts at hand. If a contact with an object via gunfire can't be avoided anymore due for example to lack of available reaction time then at least the damage should be restrained to a tolerable extend by the implemented countermeasures.

The processing unit 4 may be integrated as independent system in the technical architecture of the vehicle. Thus the processing unit 4 may be implemented easily into existing vehicles. It is a further option to conceive the processing unit 4 as part of an existing system architecture and thus use system resources of the vehicle up to now not used for the generation of risk/hazard profiles. A supplemental on board processor 17 may be provided with priorities as to control commands for counter measures. The supplemental on board processor 17 may serve as well as an interface for the plurality of sensors 6, 7, 8.

The optional storage elements 5 of the system 1 have the task, to store current and/or temporary data for further processing and serve at the same time as an address for already stored data, accessible to the system as well from external data sources.

The system 1 may consist solely of the processing unit 4 being technically linked to the other system components of the detection unit 2 and/or the data receiving- and -transmitting unit 3.

### REFERENCE LIST

1 system
2 detection unit
3 data receiving- and -transmitting unit
4 processing unit
5 optional storage elements
6 sensor
7 sensor
8 sensor
9 situation data
10 vehicle condition data
11 surrounding data
12 external technical system
13 interface
14 application data
15 vehicle display
16 action profiles

What is claimed is:

1. A vehicle system for a situation specific evaluation of risks in a surrounding of said vehicle, comprising:
a detection unit for detecting and providing of situation specific data;
a data transmitting unit and a data receiving unit, processing data from sources of data and communicating necessary data for such processing; and
a processing unit, generating application data based on received data and on supplemental data stored in the processing unit, characterized in that said vehicle is an aircraft, and in that the supplemental data in the processing unit for a situation specific profile of hazards/risks includes information regarding status with the determination of any damage in order to give a detailed status of remaining operability of the aircraft and that suitable measures for maneuver control of the aircraft depending from such supplemental data is started.

2. A system according to claim 1, wherein the detection unit comprises technical means providing specific information regarding the surrounding data of the vehicle in order to derive data with respect to the surrounding.

3. A system according to claim 1, wherein the processing unit inquires about the operation and configuration condition of the vehicle in order to derive vehicle data for calculation of a risk/hazard profile.

4. A system according to claim 1, wherein the detection unit comprises means of recognition and classification of oncoming objects in the surrounding of the vehicle for generation of situation data.

5. A system according to claim 1, wherein the processing unit comprises an interface for data transfer to other vehicles or technical information units for exchange of received data and/or application data.

6. A system according to claim 1, wherein the provided application data are transferred to at least one display unit of the vehicle.

7. A system according to claim 1, wherein encrypting means are provided encoding data communication.

8. A method for a situation specific evaluation of situations under fire in a surrounding of a vehicle system according to claim 1, wherein:
said vehicle being an aircraft:
detecting of oncoming objects in the surrounding of the aircraft for generating of situation data;
receiving data for calculating a current profile of surrounding and for generating surrounding data;
inquiring of data with respect to aircraft condition and configuration including information regarding status with the determination of any damage in order to give a detailed status of the remaining operability of the aircraft for generating of vehicle data; and
calculating of a risk-/hazard profile and conceiving measures on the basis of situation data, vehicle data and surrounding data.
